(19) United States
(12) Patent Application Publication
(10) Pub. No.: US 2019/0303746 A1
(43) Pub. Date: Oct. 3, 2019

(54) MULTILAYER NEURAL NETWORK LEARNING APPARATUS AND METHOD OF CONTROLLING THE SAME

(71) Applicant: CANON KABUSHIKI KAISHA, Tokyo (JP)

(72) Inventors: Takayuki Saruta, Tokyo (JP); Katsuhiko Mori, Kawasaki-shi (JP)

(21) Appl. No.: 16/368,970

(22) Filed: Mar. 29, 2019

(30) Foreign Application Priority Data
Apr. 2, 2018 (JP) 2018-071041

(51) Int. Cl. G06N 3/04; G06N 3/08

(52) U.S. Cl. CPC G06N 3/0454; G06N 3/08

(57) ABSTRACT

To enable efficient learning a neural network in an adaptive domain, a learning apparatus for learning a multilayer neural network (multilayer NN), comprises: a first learning unit configured to learn a first multilayer NN by using a first data group; a first generation unit configured to generate a second multilayer NN by inserting a conversion unit for performing predetermined processing between a first layer and a second layer following the first layer in the first multilayer NN; and a second learning unit configured to learn the second multilayer NN by using a second data group different in characteristic from the first data group.

### BACKGROUND OF THE INVENTION

### Field of the Invention

The present invention relates to learning of multilayer neural networks (NN).

### Description of the Related Art

A technique for learning and recognizing the contents of image data and sound data exists. For example, there are various recognition tasks such as a face recognition task that detects a region of the face of a human from an image, an object category recognition task that discriminates the category of an object in an image, and a scene type recognition task that discriminates the type of scene. A neural network (NN) technique is known as a technique for learning and executing these recognition tasks. Especially deep NNs (having a large number of layers) of these NNs are called DNNs (Deep Neural Networks). In particular, DCNNs (Deep Convolutional Neural Networks) as disclosed in Krizhevsky, A., Sutskever, I., Hinton, G. E., “Imagenet classification with deep convolutional neural networks.”, In Advances in neural information processing systems (pp. 1097-1105), 2012 (non-patent literature 1) are recently attracting attention because they have high performance.

Also, methods of improving the neural network learning accuracy have been proposed. Japanese Patent Laid-Open No. 5-274455 (patent literature 1) discloses a technique that holds the output result of an interlayer during pre-training, and learns a synapse connection (weight) by using a desired output with respect to an input pattern and the value of the interlayer as teaching values under the presence of a user. Also, Japanese Patent Laid-Open No. 7-160660 (patent literature 2) discloses a technique that gives only additional data to a learned neural network, adds a corresponding additional output neuron, and learns only a coupling coefficient of the additional output neuron and an interlayer.

Since the DCNN has a large number of parameters to be learned, learning using a large amount of data must be performed. For example, the number of 1000-class image classification data provided by ILSVRC (ImageNet Large Scale Visual Recognition Challenge) is 1,000,000 or more. Therefore, when the user learns a neural network with respect to data in a given domain, he or she first performs learning (pre-training) by using a large amount of data. After that, the user often further performs learning (fine tuning) by using data of an adaptive domain specialized for a specific domain, such as the use of a recognition task.

If, however, the adaptive domain has only a small amount of data or the data characteristic of the adaptive domain is largely different from the characteristic of the data used in pre-training, it is difficult to learn a neural network having a high identification accuracy to the adaptive domain. Even when using the above-described conventional techniques, the identification accuracy is sometimes insufficient in an adaptive domain specialized for a specific use of a neural network to be learned. In addition, it is not easy to prevent an increase in scale of a neural network when learning an adaptive domain specialized for a specific use. In the DCNN, therefore, it is necessary to efficiently learn neural network parameters when the amount of learning data of an adaptive domain is small.

### SUMMARY OF THE INVENTION

According to one aspect of the present invention, a learning apparatus for learning a multilayer neural network (multilayer NN), comprises: a first learning unit configured to learn a first multilayer NN by using a first data group; a first generation unit configured to generate a second multilayer NN by inserting a conversion unit for performing predetermined processing between a first layer and a second layer following the first layer in the first multilayer NN; and a second learning unit configured to learn the second multilayer NN by using a second data group different in characteristic from the first data group.

The present invention provides a technique that efficiently learns a neural network in an adaptive domain.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view exemplarily showing the whole configuration of a system;

FIG. 2 is a view exemplarily showing an image of an identification target;

FIG. 3 is a view showing an example of the hardware configuration of each apparatus;

FIGS. 4A to 4D are views each showing the structure of a DCNN and an example of an identification process using the DCNN;

FIGS. 5A and 5B are views each showing an example of the functional configuration of an information processing apparatus;

FIGS. 6A to 6D are views showing examples of the functional configurations of NN learning apparatuses according to the first to third embodiments;

FIGS. 7A to 7C are views showing examples of the functional configurations of NN learning apparatuses according to the fourth to sixth embodiments;

FIGS. 8A and 8B are flowcharts of the identification process performed by the information processing apparatus;

FIGS. 9A to 9F are flowcharts of a learning process performed by the NN learning apparatus;

FIG. 10 is a view showing an example of the final layer of an NN in an NN learning step;

FIGS. 11A and 11B are views showing examples of the processing contents and output results of each layer of the NN in the NN learning step;

FIGS. 12A and 12B are views showing examples of the processing contents and output results of each layer of the NN and a conversion unit;

FIGS. 13A and 13B are views showing other examples of the processing contents and output results of each layer of the NN and the conversion unit;

FIGS. 14A and 14B are views showing examples of the processing contents and output results of each layer of the NN after the NN is reduced in weight;

FIG. 15 is a view exemplarily showing a GUI for accepting the selection of an NN to be reduced in weight;

FIGS. 16A and 16B are views showing examples of the processing contents in a conversion unit addition step according to the second embodiment;

FIG. 17 is a view exemplarily showing a GUI for accepting the selection of an NN;

FIG. 18 is a view exemplarily showing a GUI for accepting the setting of learning data; and

FIG. 19 is a view exemplarily showing a GUI for accepting the selection of an adaptive domain.

### DESCRIPTION OF THE EMBODIMENTS

Examples of the embodiments of the present invention will be explained in detail below with reference to the accompanying drawings. Note that the following embodiments are merely examples and are not intended to limit the scope of the present invention.

### First Embodiment

The first embodiment of an information processing apparatus according to the present invention will be explained below by taking a system including an information processing apparatus 20 and an NN learning apparatus 50 as an example.

<Technical Premises>

A DCNN has a network structure in which each layer performs a convolution process on an output result from a preceding layer and outputs the processing result to a succeeding layer. The final layer is an output layer representing the recognition result. A plurality of convolution operation filters (kernels) are prepared for each layer. A layer close to the output layer generally has a fullconnect structure such as an ordinary neural network (NN), instead of a convolutional connect. Alternatively, a method of performing identification by inputting the output result from a convolution operation layer (interlayer), instead of a fullconnect layer, to a linear identification device, as disclosed in non-patent literature 2 (Jeff Donahue, Yangqing Jia, Judy Hoffman, Trevor Darrell, “DeCAF: A Deep Convolutional Activation Feature for Generic Visual Recognition”, arxiv 2013).

In the learning phase of the DCNN, the value of a convolution filter and the connecting weight of the fullconnect layer (collectively called learning parameters) are learned from teaching data by using a method such as back propagation (BP).

In the recognition phase, data is input to a learned DCNN and sequentially processed by learning parameters learned in each layer, and the recognition result is obtained from the output layer or obtained by adding up the output results of interlayers and inputting the sum to an identification device.

<System Configuration>

FIG. 1 is a view exemplarily showing the whole configuration of the system. This system includes a camera 10 and the information processing apparatus 20 connected across a network 15. Note that the information processing apparatus 20 and the camera 10 may also be an integrated apparatus. In addition, the information processing apparatus 20 and the neural network (NN) learning apparatus 50 are connected across the network 15. Note that the information processing apparatus 20 and the NN learning apparatus 50 may also be integrated.

The camera 10 obtains an image as an information processing target of the information processing apparatus 20. Referring to FIG. 1, an image is obtained by imaging a scene 30 as an object by the camera 10 that performs imaging at a predetermined viewing angle (imaging range). In this example, the scene 30 includes a tree 30a, a car 30b, a building 30c, a sky 30d, a road 30e, a body 30f, and the like.

The information processing apparatus 20 determines whether each object in the scene 30 imaged (captured) by the camera 10 exists in the image (that is, performs image classification). In this example, this process will be explained as an image classification task. However, the process may also be a task for detecting the position of an object and extracting an object region, or another task. An explanation of another task will be described later.

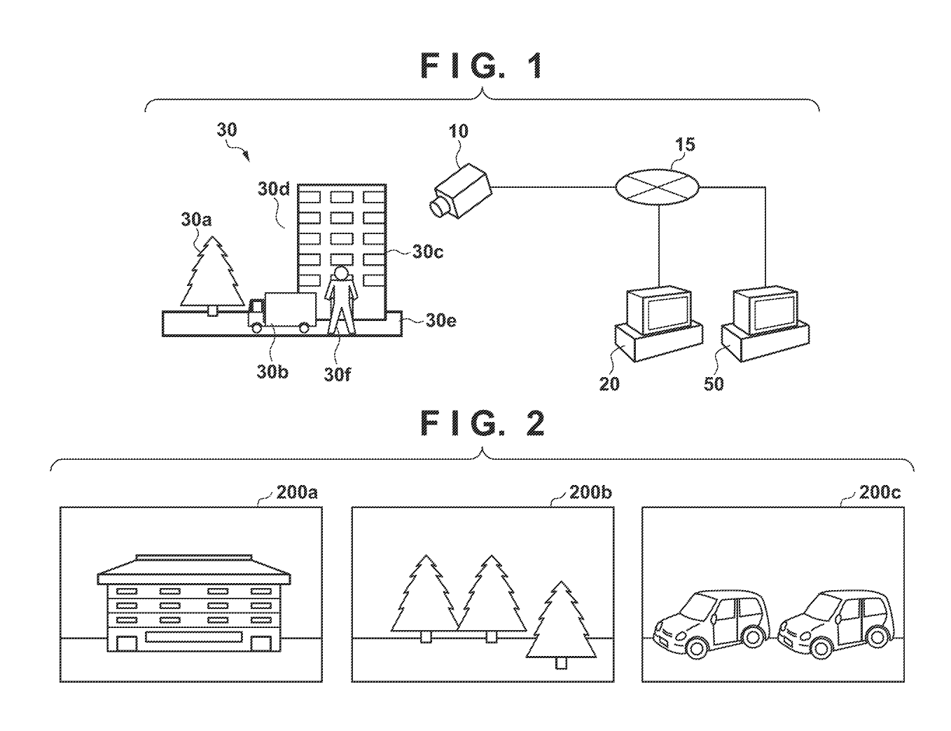

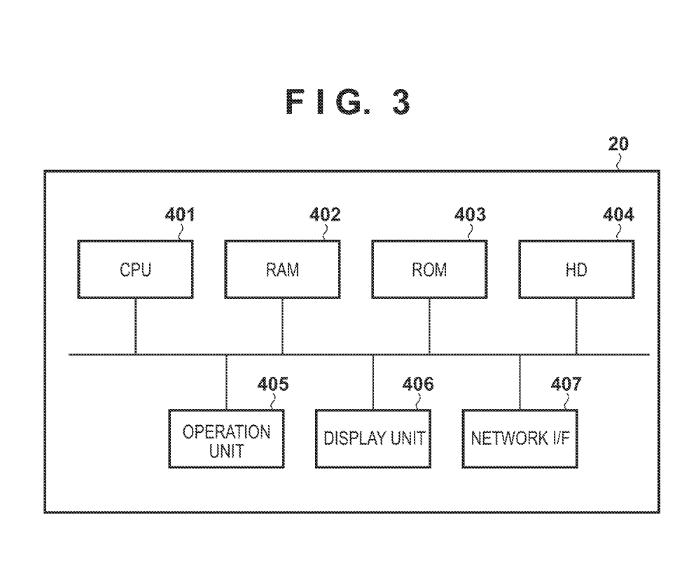

FIG. 2 is a view exemplarily showing an image as an identification target. Images 200a, 200b, and 200c depict examples of images classified as “a building”, “trees (woods/forest)”, and “cars”, respectively.

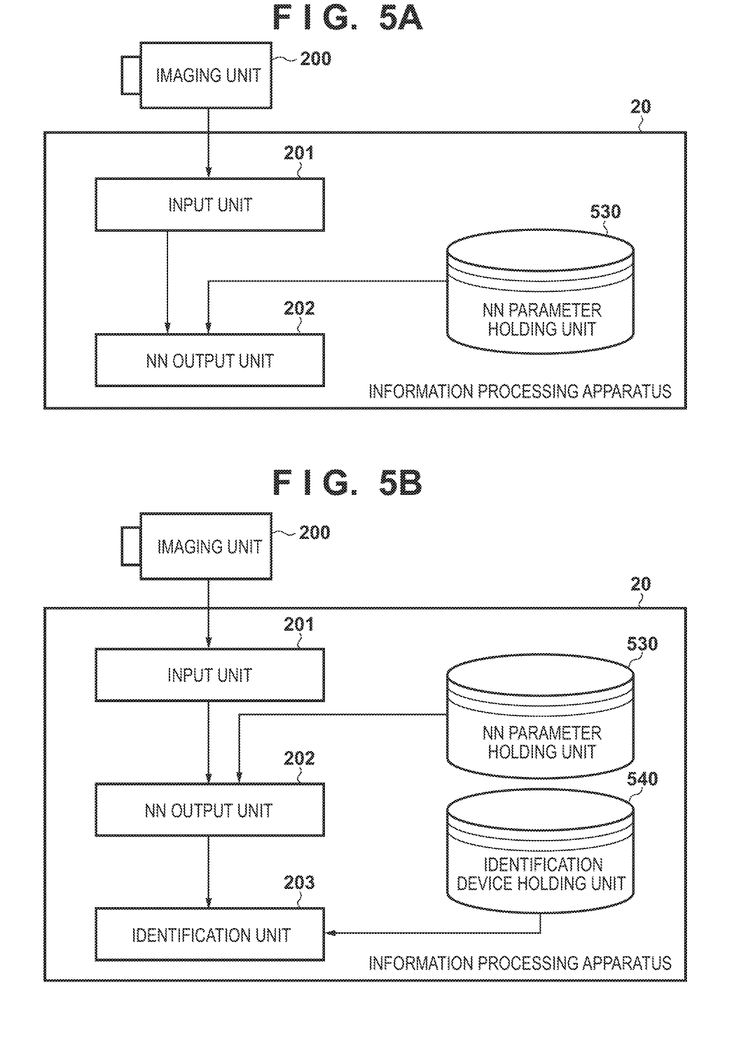

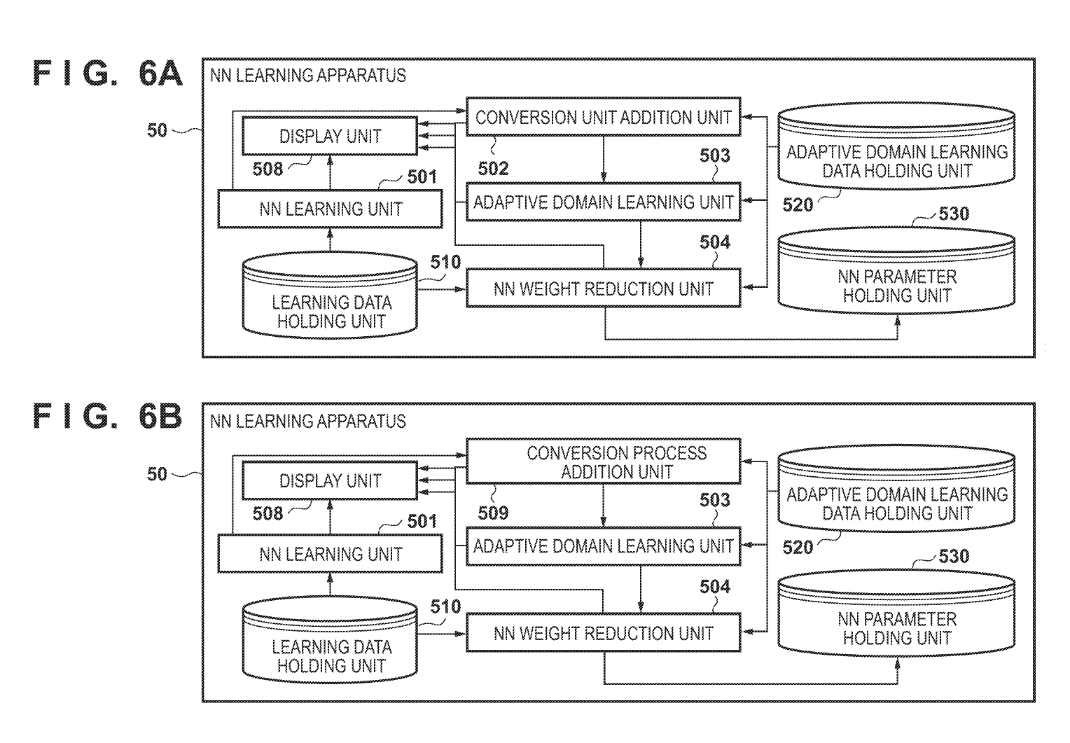

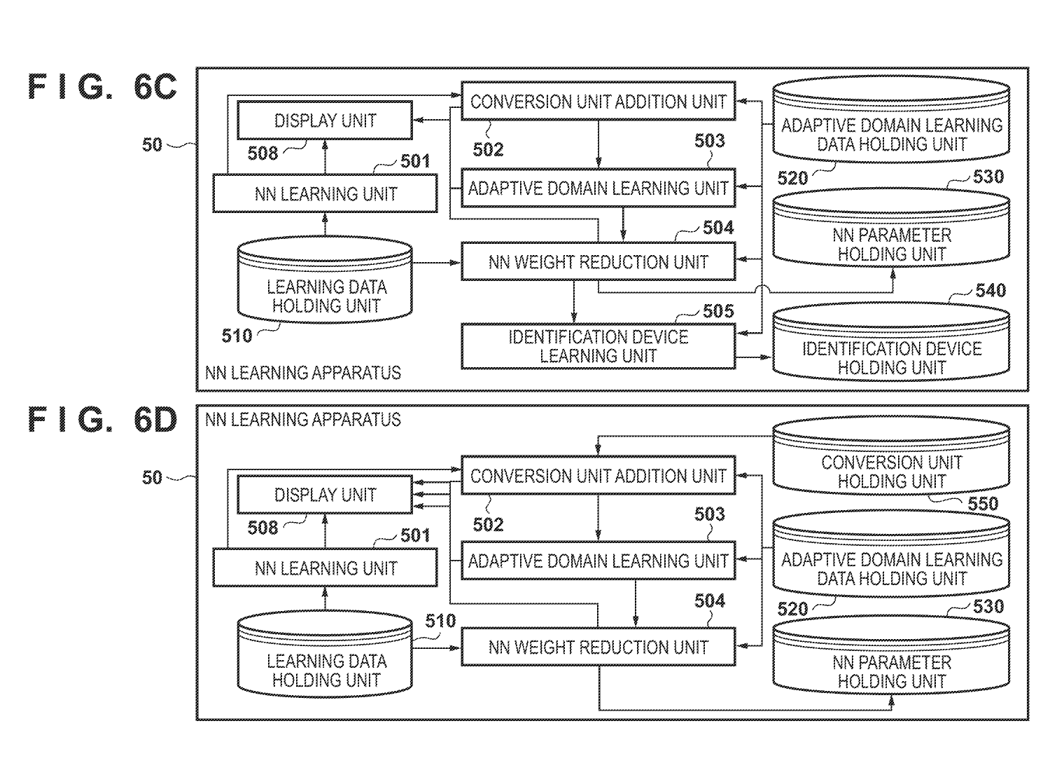

FIG. 3 is a view showing an example of the hardware configuration of the information processing apparatus 20 and the NN learning apparatus 50. A CPU 401 controls the whole of the information processing apparatus 20 and the NN learning apparatus 50. More specifically, the CPU 401 implements the functions of the information processing apparatus 20 and the NN learning apparatus 50 to be described later with reference to FIGS. 5A, 5B, and 6A to 6D, by executing programs stored in a ROM 403, a hard disk drive (HDD) 404, and the like.

A RAM 402 is a storage area that functions as a work area in which the CPU 401 deploys and executes a program. The ROM 403 is a storage area storing, for example, programs to be executed by the CPU 401. The HDD 404 is a storage area storing various programs to be required when the CPU 401 executes processing, and various kinds of data including data of thresholds and the like. An operation unit 405 accepts input operations by the user. A display unit 406 displays information of the information processing apparatus 20 and, if necessary, information of the NN learning apparatus 50. A network interface (I/F) 407 is an interface that connects to the network 15 in order to communicate with an external apparatus.

<Identification Process Using Multilayer Neural Network (NN)>

First, a process of identifying an image by using a neural network to be learned in the first embodiment will be explained. Note that this neural network is a DCNN. As disclosed in non-patent literature 1, the DCNN implements feature layers by combining convolution and non-linear processing (for example, relu or maxpooling). After processing in each feature layer, the image classification result (the likelihood of each class) is output through a fullconnect layer.

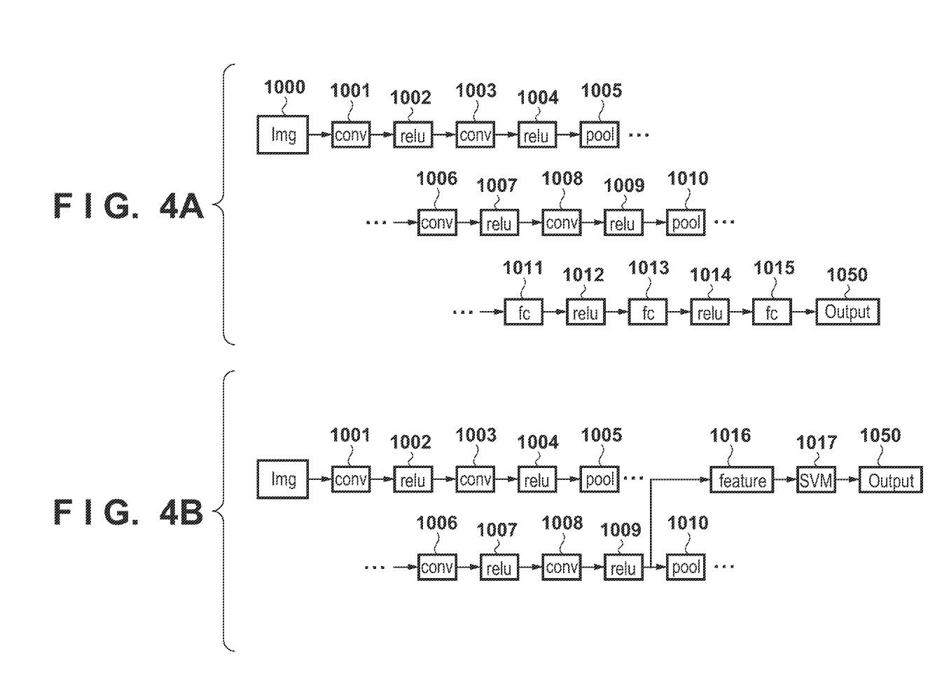

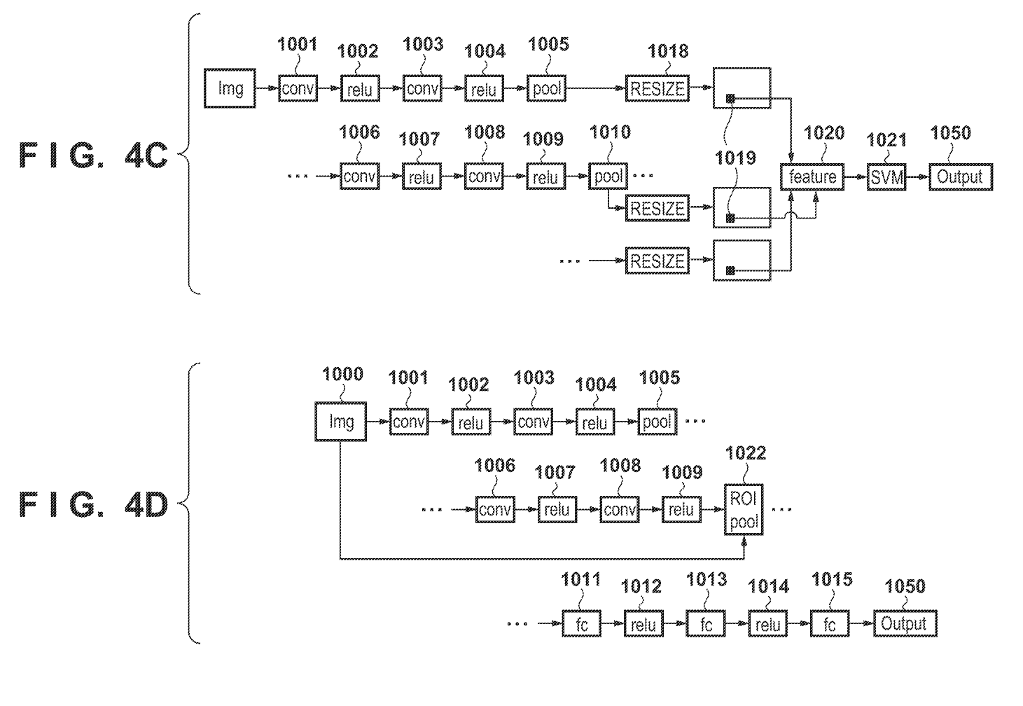

FIGS. 4A to 4D are views showing examples of the structure of the DCNN and examples of the identification process using the DCNN. Referring to FIGS. 4A to 4D, “conv” represents a layer that performs convolution, “pool” represents a layer that performs maxpooling, and “fc” represents a fullconnect layer. As disclosed in non-patent literature 1, maxpooling is a process of outputting a maximum value in a predetermined kernel size to the next layer. Also, “relu” is one of non-linear processing as disclosed in non-patent literature 1, and is a process of setting 0 (zero) as a negative value of the output result from a preceding conv layer. This “relu” may also be another non-linear processing. Furthermore, “Output” represents the output result. Note that when inputting an input image Img 1000 to the DCNN, the image is generally cropped or resized by a predetermined image size.

FIG. 4A shows an example in which the input image Img 1000 is input and processed by convolution 1001, relu 1002, convolution 1003, relu 1004, and pooling 1005. After the series of processes are repeated a predetermined number of times, an output result 1050 is output by performing processes in a fullconnect layer 1011, relu 1012, a fullconnect layer 1013, relu 1014, and a fullconnect layer 1015. Note that as disclosed in non-patent literature 2, identification may also be performed by inputting, as a feature vector, the output result of an interlayer of a neural network to an identification device.

FIGS. 4B to 4D illustrate other examples of the DCNN. For example, as shown in FIG. 4B, identification is performed by inputting the output result of a relu process 1009 of an interlayer as a feature vector feature 1016 to an SVM (Support-Vector-Machine) 1017. In this example, the output result of the relu process 1009 as an interlayer is used. However, it is also possible to use the output result of preceding convolution 1008 or a succeeding pooling process 1010, the output result of another interlayer, or a combination thereof. In addition, the SVM is used as an identification device in this example, but another identification device may also be used.

The arrangement shown in FIG. 4B uniquely outputs the output result with respect to an input image. On the other hand, an arrangement as shown in FIG. 4C is used when it is necessary to identify a pixel or a small region such as when identifying an object region. In this case, the output result of a predetermined interlayer is processed by resize 1018. The resizing process is a process of resizing the output result of the interlayer into the same size as the input image size. After this resizing process, an output result 1019 of a predetermined interlayer in a pixel of interest or a small region of interest is input to an SVM 1021, thereby performing identification as described previously. When using the DCNN, the output result of an interlayer becomes smaller than the input image size, so the output result of the interlayer must be resized to the input image size. The resizing method can be any method as long as the method is an interpolation method such as nearest-neighbor-algorithm. Note that the SVM is used in this example, but another identification device may also be used.

Furthermore, it is also possible to use a neural network disclosed in ‘Ross Girshick, “Fast R-CNN”, International Conference on Computer Vision 2015’. That is, it is also possible to use a neural network that estimates an object region candidate as an ROI (Region-Of-Interest) and outputs BoundingBox and the score of the target object region. In this case, as indicated by 1022 in FIG. 4D, a pooling process (ROIpooling) is performed on the output result of an interlayer in an ROI region estimated by a predetermined method. The output result having undergone ROIpooling is connected to a plurality of fullconnect layers, and the position and size of BoundingBox, the score of the target object, and the like are output.

<Configuration and Operation of Information Processing Apparatus>

FIG. 5A is a view showing an example of the functional configuration of the information processing apparatus 20 according to the first embodiment. In FIG. 5A, each processing to be executed by the CPU 401 of the information processing apparatus 20 is depicted as a functional block. Note that FIG. 5A shows an imaging unit 200 equivalent to the camera 10, in addition to the individual functional blocks of the information processing apparatus 20. The imaging unit 200 is equivalent to the camera 10, and obtains an identification target image. The information processing apparatus 20 includes an input unit 201, an NN output unit 202, and an NN parameter holding unit 530. Note that the NN parameter holding unit 530 may also be connected as a nonvolatile storage device to the information processing apparatus 20.

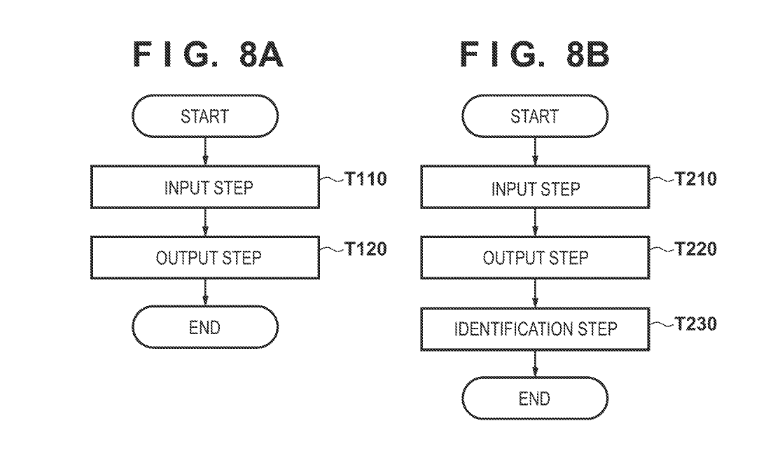

FIG. 8A is a flowchart of the identification process performed by the information processing apparatus 20 according to the first embodiment. In step T110, the input unit 201 receives an identification target image obtained by the imaging unit 200 as input data. The received identification target image is transmitted to the NN output unit 202. In step T120, the NN output unit 202 executes the identification process on the identification target image by using a neural network held in the NN parameter holding unit 530, and outputs the identification result. Since the recognition task is an image classification task, the class name and score of the image are output. A practical structure and the like of the neural network will be described later. Also, an identification unit using the output result of a neural network as a feature vector is sometimes used, such as in a method disclosed in non-patent literature 2 or ‘Bharath Hariharan, Pablo Arbelaez, Ross Girshick, Jitendra Malik, “Hypercolumns For Object Segmentation and Fine-grained Localization”, IEEE Conference on Computer Vision and Pattern Recognition 2015’. The arrangement and procedure of the information processing apparatus in this case will be explained in the second embodiment.

Next, practical processing contents in the flowchart shown in FIG. 8A will be explained. In step T110, the input unit 201 obtains an image captured by the imaging unit 200 as an identification target image 100. In this example, an image of the scene 30 as shown in FIG. 1 is obtained. Note that the identification target image may also be an image stored in an external apparatus (not shown). In this case, the input unit 201 obtains an image read out from the external apparatus as the identification target image. The image stored in the external apparatus can be an image captured by the imaging unit 200 or the like in advance, and can also be an image obtained and stored by another method such as transmission across a network or the like. The identification target image 100 obtained by the input unit 201 is transmitted to the NN output unit 202.

In step T120, the NN output unit 202 inputs the identification target image 100 input in step T110 to a pre-learned neural network. Then, the NN output unit 202 outputs the output result of the final layer of the neural network as an identification result. As the neural network used herein, it is possible to use, for example, the neural network shown in FIG. 4A. The structure and parameters of the neural network are held in the NN parameter holding unit 530.

<Configuration and Operation of NN Learning Apparatus>

FIG. 6A is a view showing an example of the functional configuration of the NN learning apparatus according to the first embodiment. In FIG. 6A, each processing to be executed by the CPU 401 of the NN learning apparatus 50 is depicted as a functional block. The NN learning apparatus 50 includes an NN learning unit 501, a conversion unit addition unit 502, an adaptive domain learning unit 503, an NN weight reduction unit 504, and a display unit 508. The NN learning apparatus 50 also includes a learning data holding unit 510, an adaptive domain learning data holding unit 520, and an NN parameter holding unit 530. The learning data holding unit 510, the adaptive domain learning data holding unit 520, and the NN parameter holding unit 530 may also be connected as nonvolatile storage devices to the information processing apparatus 20.

In the first embodiment, a multilayer neural network (multilayer NN) is learned by a large amount of data held in the learning data holding unit 510 of the NN learning apparatus 50. After that, learning is performed by using adaptive domain data (a small amount of data) held in the adaptive domain learning data holding unit 520. However, it is also possible to hold learning parameters of a neural network learned by a large amount of data beforehand, and perform only a learning process for the adaptive domain data.

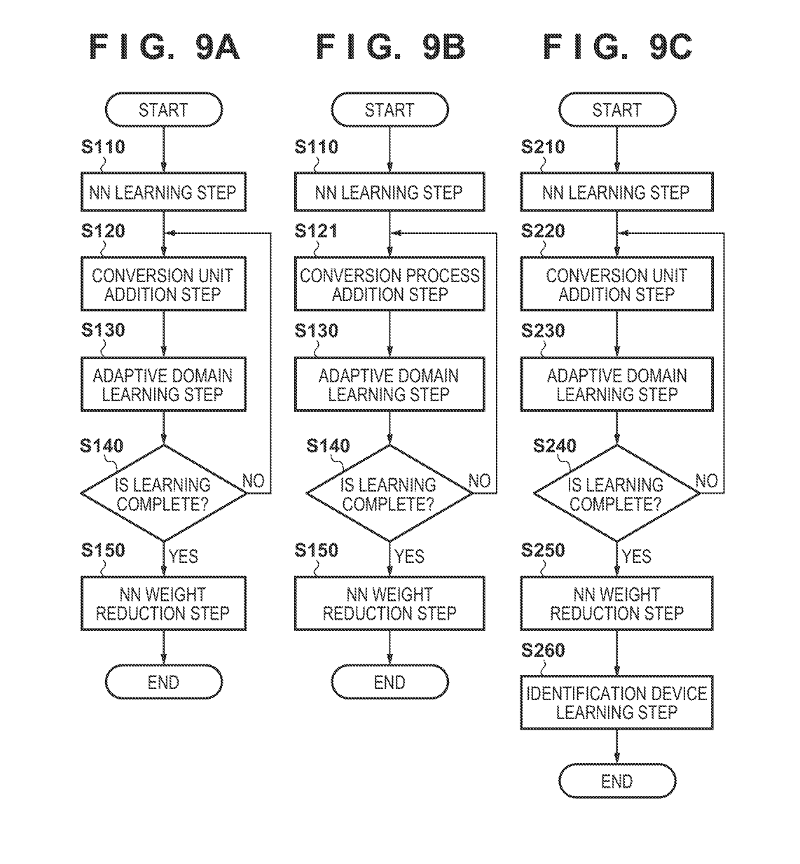

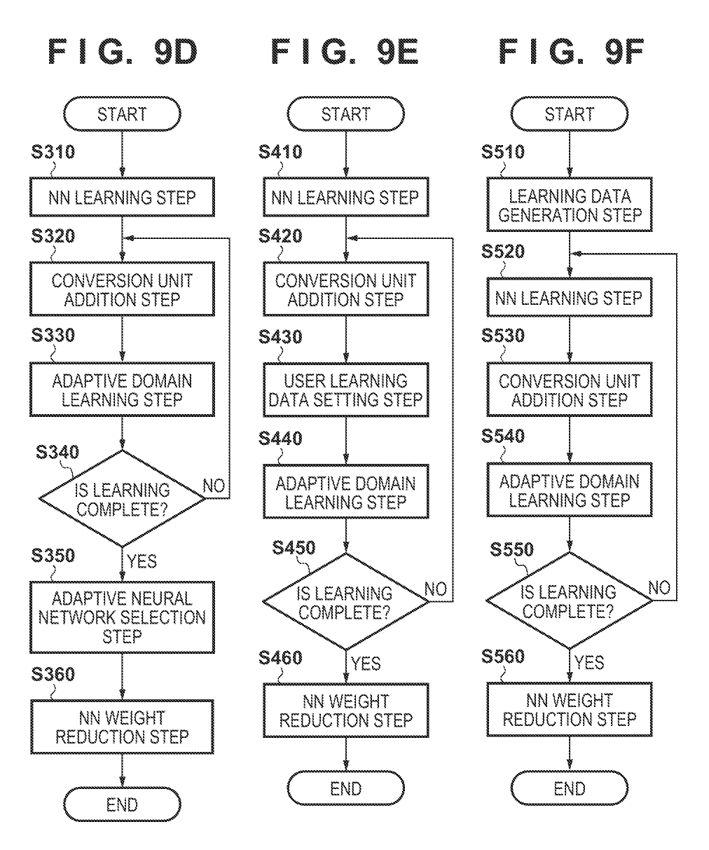

FIG. 9A is a flowchart of the learning process performed by the NN learning apparatus 50 according to the first embodiment. In step S110, the NN learning unit 501 sets parameters of a neural network, and learns the neural network by using the learning data held in the learning data holding unit 510. In this example, the DCNN explained earlier is used. Examples of the parameters to be set are the number of layers, the processing contents (structures) of the layers, the filter size, and the number of output channels. The learned neural network is transmitted to the conversion unit addition unit 502. When displaying the learning result, the learned neural network is transmitted to the display unit 508. The display of the learning result will be described later.

In step S120, the conversion unit addition unit 502 adds a conversion unit to the neural network learned in step S110. The added conversion unit has an arrangement that receives the output result of a predetermined interlayer of the neural network and inputs the conversion result to a predetermined interlayer. The processing and the addition method will be described in detail later. Also, the conversion unit addition unit 502 is connected to the adaptive domain learning data holding unit 520, and sometimes uses adaptive domain data when adding a conversion unit. In the following explanation, an example not using the adaptive domain data will be described. The arrangement and parameters of the neural network to which the conversion unit is added are transmitted to the adaptive domain learning unit 503 and the display unit 508.

In step S130, the adaptive domain learning unit 503 learns the parameters of the neural network to which the conversion unit is added in step S120, by using the adaptive domain data. The learning method will be described later. The parameters of the learned neural network are transmitted to the NN weight reduction unit 504 and the display unit 508.

In step S140, the adaptive domain learning unit 503 determines whether learning is complete. If it is determined that learning is complete, the process advances to step S150. If learning is not complete, the process advances to step S120, and a conversion unit is further added. The determination method will be described later.

In step S150, the NN weight reduction unit 504 generates a neural network having almost the same output characteristic as that of the neural network to which the conversion unit is added, or a neural network that outputs an approximate processing result. The generated neural network is reduced in weight into a smaller network scale. The method of weight reduction will be explained in detail later. FIG. 9A shows a form that performs weight reduction by using the data of the learning data holding unit 510 and the data of the adaptive domain learning data holding unit 520. However, it is also possible to separately prepare data for weight reduction. The arrangement and parameters of the lightweight neural network are transmitted to the NN parameter holding unit 530 and the display unit 508. The arrangement and parameters of the neural network held in the NN parameter holding unit 530 are used in the identification process performed by the information processing apparatus 20.

Next, practical processing contents of the flowchart shown in FIG. 9A will be explained. In step S110, the NN learning unit 501 sets the parameters of a neural network, and learns the neural network by using learning data (a first data group) held in the learning data holding unit 510. In this example, the neural network shown in FIG. 4A is learned.

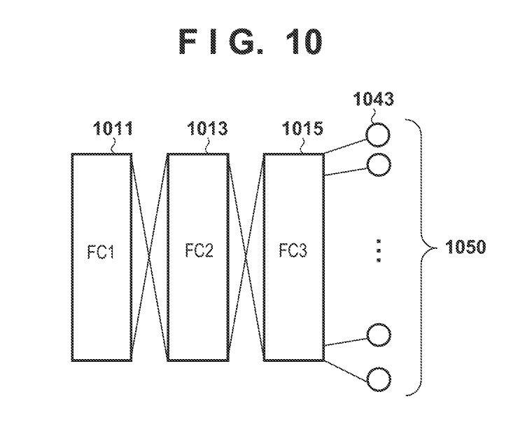

FIG. 10 is a view showing an example of the final layer of the NN in the NN learning step. For example, when learning 1000-class image classification data of an ILSVRC often used in learning of an image classification task, the number of output nodes 1050 of a final layer 1015 of fullconnect layers is set at 1,000. Then, each output 1043 is made equal to the likelihood of an image classification class allocated to each image.

During learning, an error between each output result 1043 with respect to the learning data held in the learning data holding unit 510 and a teaching value is propagated backward to the neural network. Then, the filter value (weight) of each convolution layer is updated by SGD (Stochastic Gradient Descent) or the like.

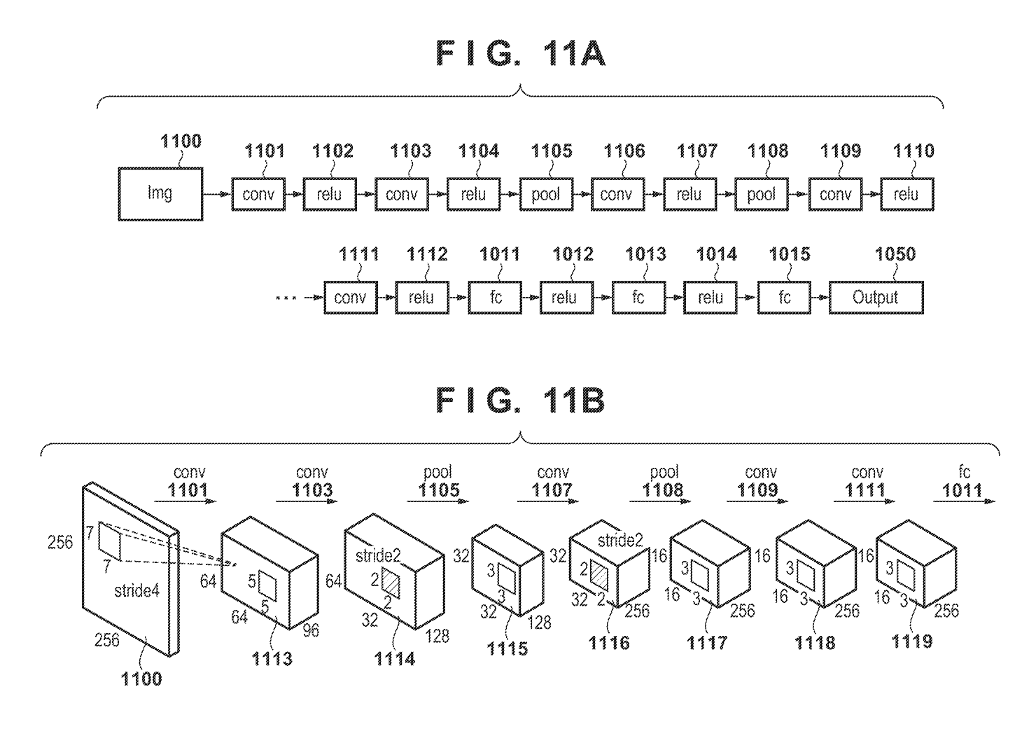

FIGS. 11A and 11B are views showing examples of the processing contents and output result of each layer of the NN in the NN learning step. FIG. 11A shows the processing contents. That is, after processes 1101 to 1112 are performed on an input learning image, the result is input to a fullconnect layer (fc). Processing in the fullconnect layer is expressed by three layers as shown in FIG. 10. FIG. 11B is a view showing the output result of each layer when performing the processing contents shown in FIG. 11A. Note that FIG. 11B omits relu processes.

In the DCNN, an Nn (n=1, 2, . . . ) channel input to each layer is converted into an Nn+1 channel output by convolution. Filters (kernels) used in each Convolution layer are represented by a four-dimensional Tensor expression. For example, the filters are represented by (filter size)×(filter size)×(number of (input) channels)×(number of filters=number of output channels).

In the example shown in FIG. 11B, the input image is resized to 256×256, and defined by three channels of RGB. Filters (kernels) used in convolution 1101 is expressed by “7×7×3×96”. As shown in FIG. 11B, processing is performed by stride4 (a convolution operation is performed for every four pixels). Accordingly, the size of the output result of the convolution 1101 (and a relu process 1102) is represented by “64×64×96” as indicated by 1113. Then, filters in processing of convolution 1103 are represented by “5×5×96×128”. Therefore, the output result of the processing of the convolution 1103 is “64×64×128”. Then, when a pooling process 1105 obtains a maximum value within the range of “2×2” by stride2, the output result is “32×32×128”. The learned neural network is transmitted to the conversion unit addition unit 502. A process of displaying the learning result will be described later.

In step S120, the conversion unit addition unit 502 adds a conversion unit to the neural network learned in step S110. As described above, the output result of a predetermined interlayer of the neural network is input to the added conversion unit, and the conversion result of the conversion unit is input to the predetermined interlayer. In this embodiment, an example in which conversion units are added to the neural network explained in FIGS. 11A and 11B will be explained.

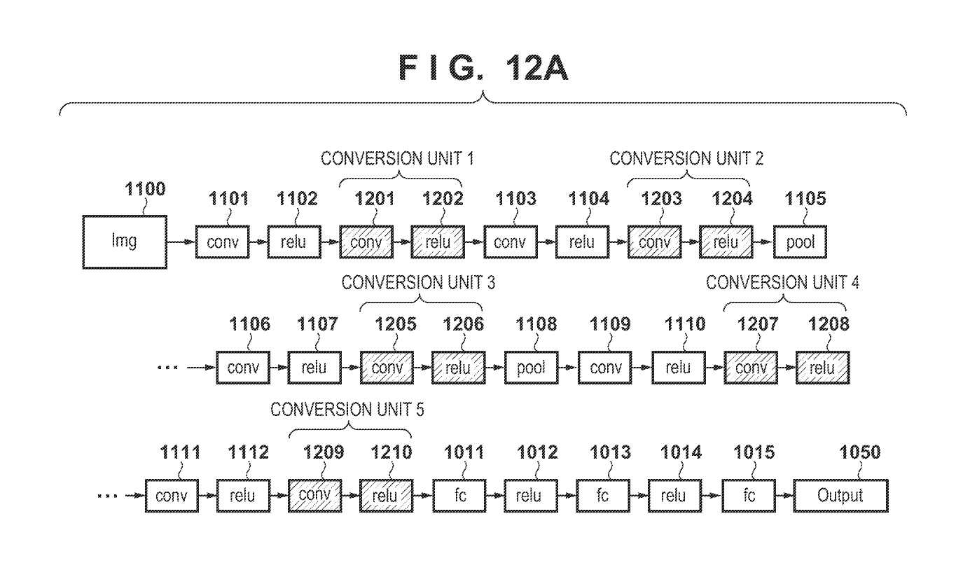

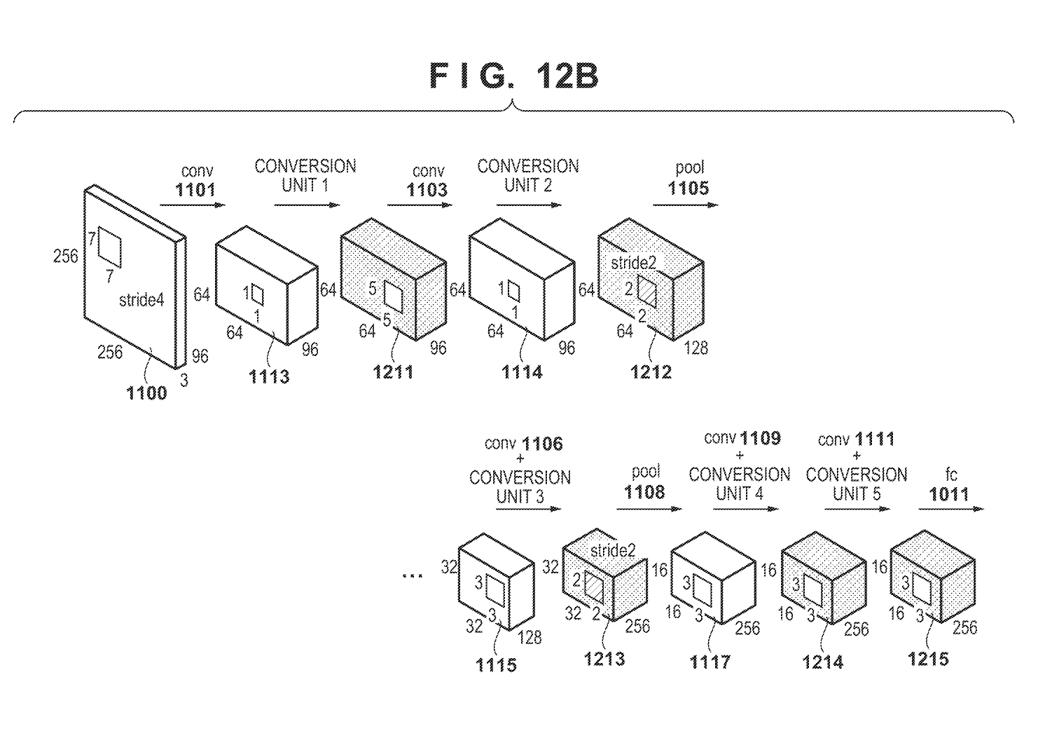

FIGS. 12A and 12B are views showing examples of the processing contents and output results of each layer of the NN and each conversion unit. FIG. 12A shows a state in which conversion units are inserted into the neural network. More specifically, conversion units 1 to 5 are inserted after relu processes 1102, 1104, 1107, 1110, and 1112. Assume that each conversion unit is defined by the convolution and relu processes. However, the conversion unit may also be configured by another predetermined spatial filter (nonlinear conversion). It is also possible to input the output result (Relay or bypass) of another layer. When the conversion units 1 to 5 are inserted, the output results of interlayers (output results 1211, 1212, 1213, 1214, and 1215 shown in FIG. 12B) are output. A method of learning parameters of the conversion unit will be explained in step S130.

Note that the kernel size of convolution of the conversion unit added in FIG. 12A is limited. For example, the input channels and output channels of convolution 1201 in the conversion unit 1 must be 96, so filters in the processing is represented by “1×1×96×96”. However, since the input channels and output channels to the conversion unit need only be 96, the convolution layer in the conversion unit may also be two layers having filters defined by “1×1×96×128” and “1×1×128×96”. The filter size is 1×1 in the explanation for the sake of simplicity, but it is also possible to use a 3×3 filter or a 5×5 filter as long as the output result remains unchanged. However, a terminating process must be performed in order to prevent a change in size of the output result. More specifically, when processing a pixel at the terminal end, 0 (zero) is input during a convolution operation in order to refer to the outside of the screen. Also, the number of parameters is preferably small in order to facilitate performing learning in succeeding step S130, so it is desirable not to set a too large filter size. Furthermore, input to the neural network can also be performed after branching from an interlayer and performing processing in the conversion unit.

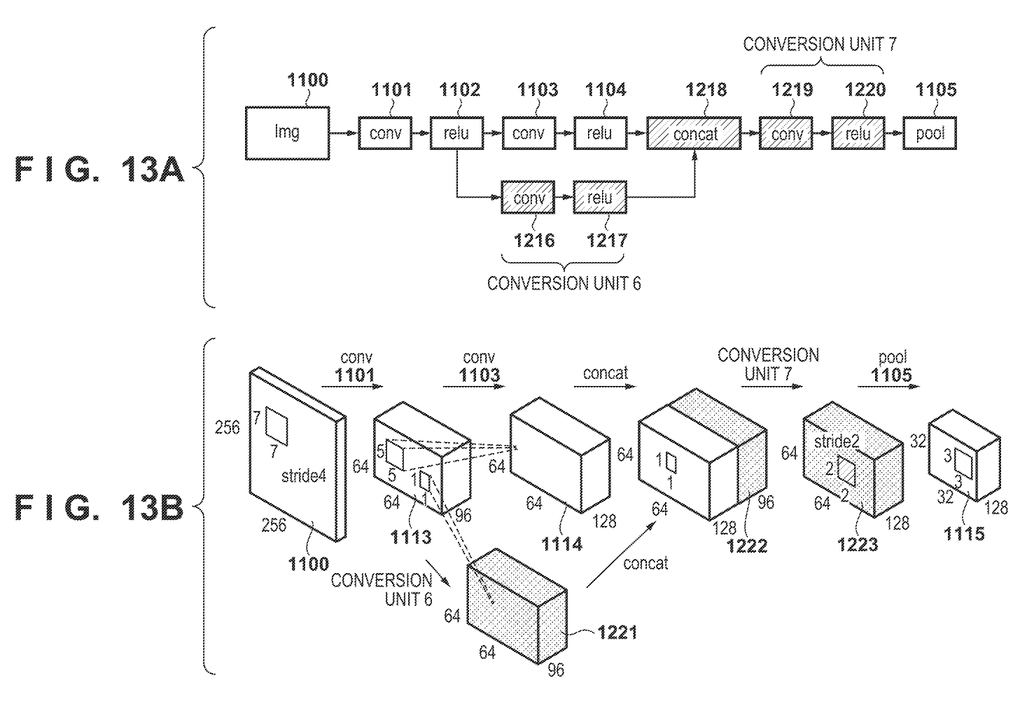

FIGS. 13A and 13B are views showing other examples of the processing contents and output results of each layer of the NN and conversion units. FIG. 13A shows a state in which conversion units are inserted into the neural network. More specifically, after convolution 1101 and a relu process 1102 are performed, the neural network branches into two parts, that is, processing of convolution 1103 and processing of convolution 1216 in a conversion unit 6. In this example, an output result 1113 of an interlayer is input to the convolution 1103 and a relu process 1104 defined by a filter size “5×5×96×128”. In parallel to that, the output result is input to the convolution 1216 and a relu process 1217 in the conversion unit 6 defined by a filter size “1×1×96×96”. Furthermore, output results 1114 and 1221 are concatenated (concat processing). The concat processing is to perform concatenation in the output channel direction. The concatenation result is indicated by a concatenation result 1222 shown in FIG. 13B, and the size of the concatenation result is represented by “64×64×(128+96)”. The concatenation result is further input to convolution 1219 and a relu process 1220 (a conversion unit 7) defined by a filter size “1×1×(128+96)×128”. After that, the result is connected to a pooling process 1105 as one processing in the original neural network. Note that FIG. 13A is merely an example, and it is also possible to add a conversion unit having another branching structure. In addition, an arrangement in which a conversion unit is connected between a branching structure and an interlayer may also be mixed. However, the output result of an interlayer which is input to a conversion unit and the output result from the conversion unit must have the same size.

Note that the arrangements of the conversion unit have been explained by using the DCNN, but it is also possible to use another multilayer neural network. In addition, a conversion unit defined by MLP (Multilayer Perceptron) can be added to the DCNN as described in ‘Min Lin, “Network In Network”, International Conference on Learning Representations 2014’. In this case, however, the number of parameters may increase from that of the DCNN, so it is sometimes necessary to make an improvement, for example, perform adaptive domain learning by adding layers one by one. An improvement of learning like this will be explained in step S130 to be described later.

Also, as explained previously, the output result of an interlayer to be input to a conversion unit and the output result from the conversion unit need only have the same size, so a function (filter operation) like that need only be defined. For example, the size of the output result of an interlayer to be input to the conversion unit 1 shown in FIG. 12A is “64×64×96”, so a filter operation that outputs a conversion result having the size “64×64×96” need only be defined. For example, it is possible to use a filter (a mean filter or a Gaussian filter) defined by “3×3”. Parameters of the filter can be learned in step S130, and can also be multiplied by the parameters of the neural network. In this case, the conversion process is so configured as to form a part of the neural network, and the arrangement and parameters of the neural network to which the conversion process is added are transmitted to the adaptive domain learning unit 503.

FIG. 6B shows the functional blocks of processing to be executed by the CPU 401 of the NN learning apparatus 50 when adding the conversion process. FIG. 9B shows an outline of the processing to be executed by each functional block of the NN learning apparatus 50. The processing contents are basically the same as those explained in FIGS. 6A and 9A, except that a conversion process addition unit 509 is added instead of the conversion unit addition unit 502. Also, step S121 is added instead of step S120 in the flowchart of the learning process. The rest of the processing are the same, so an explanation thereof will be omitted.

In step S130, the adaptive domain learning unit 503 learns parameters of the neural network to which the conversion units are added in step S120, by using the adaptive domain data. The learning method when using the arrangements shown in FIGS. 12A and 12B in step S120 will be explained below. The adaptive domain learning unit 503 learns the parameters of the neural network to which the conversion units are added in step S120, by using data (a second data group) held in the adaptive domain learning data holding unit 520. The processing is basically the same as in step S110, that is, an error between each output result with respect to the learning data held in the adaptive domain learning data holding unit 520 and a teaching value is propagated backward to the neural network. Then, the filter value (weight) of each convolution layer and the connection weight of a fullconnect layer as an identification layer are updated by stochastic gradient descent. The initial value of the filter value (weight) of each convolution layer in the conversion unit can be a random value, but it may also be defined by identity mapping (mapping by which an input vector and an output vector have the same output). For example, the filter size used in the processing of the convolution layer 1201 in the conversion unit 1 explained with reference to FIG. 12A is defined by “1×1×96×96”. Therefore, when the filter value is represented by f(1, 1, i, j) (i=1, 2, . . . , 96, j=1, 2, . . . , 96), the filter value is represented by equation 1:

f(1,1i,j)=1(i=j)

f(1,1,i,j)=0(i≠j) (1)

Since learning is performed by using identity mapping as the initial value, no learning is performed (the filter value is not largely updated) if it is unnecessary to change the parameters of the original neural network when learning the adaptive domain data. By contrast, the filter value is largely updated if it is necessary to change the parameters of the original neural network when learning the adaptive domain data. When repeating the processing in step S120, it is possible to add conversion units before and after the conversion unit whose filter value is largely updated, or change the arrangement of the conversion unit.

Since, however, the conversion units are added to the neural network defined in step S110, the number of parameters to be learned has increased. In addition, the amount of learning data in the adaptive domain is often smaller than that of the learning data used in step S110. This sometimes makes it difficult to learn the parameters of all layers at once. In this embodiment, therefore, the learning rate of each convolution layer corresponding to elements of the neural network other than the conversion units, that is, the neural network learned in step S110, is set to 0 (zero). That is, the filter value (weight) of each convolution layer corresponding to the neural network learned in step S110 is not updated. Since this processing decreases the number of parameters to be learned, highly accurate learning can be performed even when the amount of learning data in the adaptive domain is small. It is also possible to first perform learning by setting the learning rate of the conversion unit to 0 (zero), and then learn the parameters of the whole neural network again. Even in this case, however, the learning rate is desirably set at a small value because over-adaptation may occur if the learning rate is increased. Also, the learning rate of each layer of the neural network learned in step S110 is set to 0 (zero) in the above explanation, but this learning rate need only be set at a value smaller than that of the conversion unit. It is also possible to set the learning rates of conversion units such that the learning rate of a conversion unit closer to the input layer has a smaller value. By performing these learning methods, the conversion units are learned in accordance with the difference between the characteristics of a large number of images and the adaptive domain. In addition, regarding the parameters of elements of the neural network other than the conversion units, the parameters learned by a large number of images in step S110 are inherited, so it is possible to learn a highly accurate neural network.

Generally, in a deep model such as the DCNN, domain-dependent activity easily occurs in a layer close to the input layer, and activity specialized to a recognition task easily occurs in a layer close to the output layer. When an adaptive domain is learned in an arrangement in which a conversion unit is connected between interlayers as shown in FIGS. 12A and 12B, learning specialized to the characteristic of the adaptive domain is performed.

For example, a conversion unit close to the input layer is largely activated when an image of an adaptive domain is a deteriorated image or a blurred image. When identifying an image obtained by an imaging unit, learning specialized to the characteristics of the imaging unit can be performed. This is effective when, for example, an adaptive scene is a scene to be imaged by a fixed camera. Furthermore, since activity specialized to a recognition task easily occurs in a layer close to the output layer, learning specialized to an event that often appears in the adaptive scene is performed. For example, even in the same body detection task, if learning is performed by using a large number of images, learning for detecting bodies with various postures, clothes, and lighting patterns is usually performed. When using the above-described method, learning is so performed as to more reliably detect postures, clothes, and lighting patterns that often appear in the adaptive scene. As described above, a large number of images are normally necessary to learn a neural network, so images obtained in various scenes and situations are often used. When using the method of this embodiment, however, each conversion unit is learned as needed in accordance with an adaptive scene.

Note that an example in which a plurality of conversion units are added at the same time in step S120 has been explained above. However, it is also possible to add conversion units one by one, or perform learning by setting the learning rates of some conversion units to 0 (zero). Since this can further reduce the number of parameters to be updated at once when learning the neural network in step S130, efficient learning can be performed. It is also possible to perform learning in an adaptive domain by adding a plurality of patterns of conversion units, and perform selection by comparing identification accuracies with respect to the adaptive domain data. The processing contents in this case will be explained in the fourth embodiment. The learned neural network parameters are transmitted to the NN weight reduction unit 504.

In step S140, the adaptive domain learning unit 503 determines whether learning is complete. If it is determined that learning is complete, the process advances to step S150. If learning is not complete, the process advances to step S120, and a conversion unit is further added. The determination can be performed in accordance with the numbers of times of the processes in steps S120 and S130, and can also be performed by evaluating the identification accuracy with respect to the adaptive domain data of the neural network learned in step S130. It is also possible to further add a conversion unit or replace a conversion unit with another conversion unit when repeating the processing in step S120.

In step S150, the NN weight reduction unit 504 reduces the weight of the neural network learned in step S130. In this embodiment, an example in which the process of weight reduction is performed by using all data held in the learning data holding unit 510 and the adaptive domain learning data holding unit 520 will be explained. Also, a method of reducing the weight of the neural network which is explained in FIGS. 12A and 12B and to which the conversion units are added will be explained. More specifically, an image is input to the neural network which is explained in FIGS. 12A and 12B and to which the conversion units are added, and the output results of interlayers and the final layer except the conversion units are extracted. Then, by using the output results as teaching values of interlayers and the final layer of a lightweight neural network, a neural network reduced in weight by removing the conversion units from the neural network including the conversion units is learned.

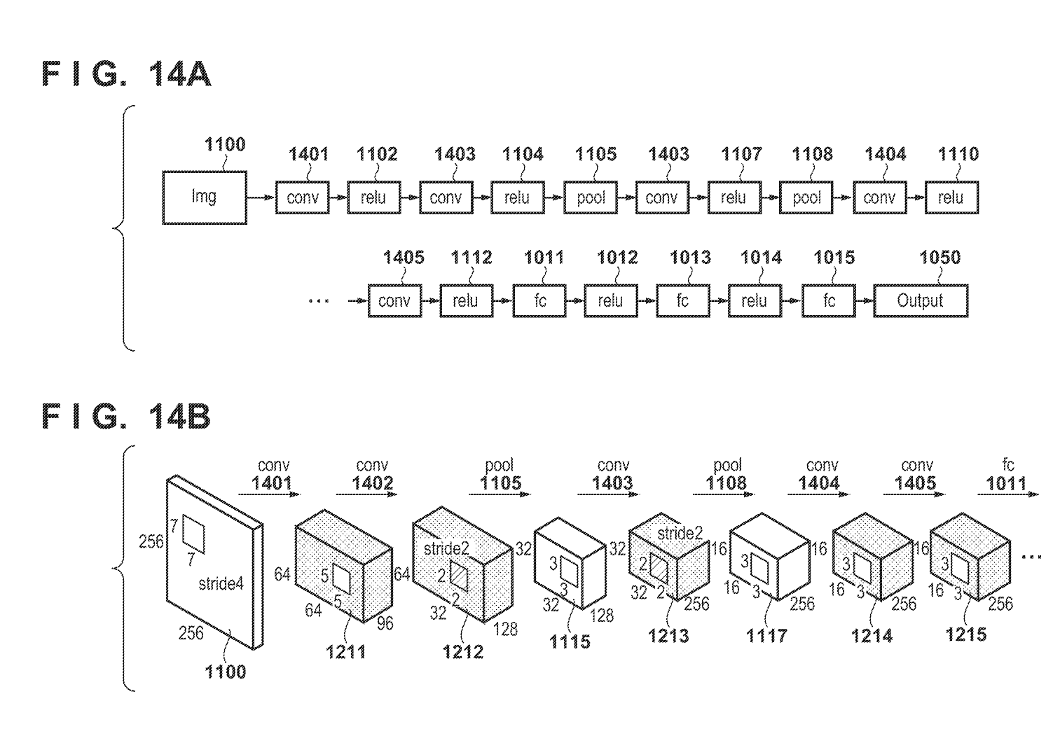

FIGS. 14A and 14B are views showing examples of the processing contents and output results of individual layers of the NN after the weight of the NN is reduced. FIG. 14A is a lightweight neural network for performing the same processing as that of the neural network learned in step S110 shown in FIG. 11A. However, the filter values (weights) of convolution layers 1401, 1402, 1403, 1404, and 1405 are updated. FIG. 14B is a view showing output results 1211, 1212, 1213, 1214, 1215, 1115, and 1117 of interlayers of the lightweight neural network. Note that the output results 1211, 1212, 1213, 1214, 1215, 1115, and 1117 are the same as the output results 1211, 1212, 1213, 1214, 1215, 1115, and 1117 of the interlayers explained in FIG. 12B.

Learning can be updated by stochastic gradient descent or the like as in steps S110 and S130. In this example, it is assumed that weight reduction is performed by using all data held in the learning data holding unit 510 and the adaptive domain learning data holding unit 520. However, it is also possible to use only the adaptive domain learning data, or perform weighting between the adaptive domain data and data other than the adaptive domain data. Furthermore, teaching values to be given to each interlayer and the final layer can also be weighted. For example, the weight is so set as to increase from the input layer to the final layer. The filter value is lamely updated by weighting when learning the adaptive domain. It is also possible to select an interlayer to be used as a teaching value.

Note that the weight reducing method performed in step S150 is not limited to the method explained herein. For example, weight reduction may also be performed by a method of compressing each filter by using the technique of matrix decomposition such as low-rank approximation. Alternatively, compression can be performed such that the output result of the final layer becomes the same result, as disclosed in ‘Geoffrey Hinton, “Distilling the Knowledge in Neural Network”, arxiv 2015’.

The above processing makes it possible to learn a neural network having a high identification accuracy in an adaptive domain while suppressing an increase in network scale. Note that the example in which the weight of the neural network is reduced by the processing in step S140 after the learning processes (steps S120 and S130) are repeated several times has been explained above. However, the processing in step S120 may also be performed again after the processing in step S140 is performed. In this case, learning in the adaptive domain is performed while performing NN weight reduction. Accordingly, learning can be performed without increasing the scale of the neural network during adaptive domain learning even if conversion units are added a plurality of times.

<Display Process>

An information display process on the display unit 508, which corresponds to each processing described above, will be explained below. The NN learning unit 501, the conversion unit addition unit 502, the adaptive domain learning unit 503, and the NN weight reduction unit 504 are connected to the display unit 508, so the display unit 508 can display the processing contents and results of these units.

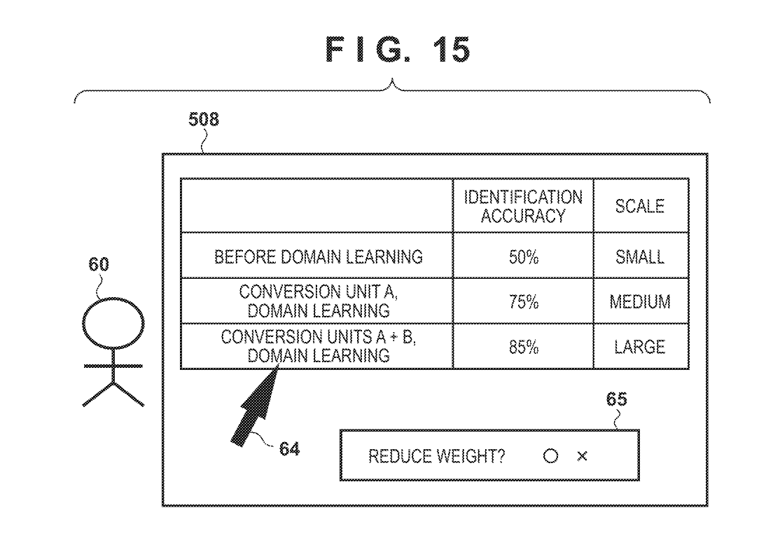

FIG. 15 is a view exemplarily showing a graphical user interface (GUI) that accepts selection of an NN to be reduced in weight. More specifically, the display unit 508 displays the results of adaptive domain learning performed by adding conversion units a plurality of times. FIG. 15 particularly shows the way a user 60 selects one of a plurality of neural networks by using a pointer 64 on the display unit 508. The display unit 508 also displays a dialogue 65 for accepting whether to perform weight reduction on the selected neural network. For example, the user 60 selects a large-scale neural network and inputs an instruction to perform weight reduction, thereby executing the process of reducing the weight of the neural network.

In the first embodiment as has been explained above, the NN learning apparatus 50 learns a neural network by using a large number of images, and adds conversion units for learning an adaptive domain. The NN learning apparatus 50 learns the neural network to which the conversion units are added by using adaptive domain data, and generates a neural network that outputs the same result by performing the weight reduction process. These processes make it possible to learn a neural network having a high identification accuracy in an adaptive domain while suppressing an increase in network scale.

### Second Embodiment

In the second embodiment, after a neural network in an adaptive domain is learned, an identification device (for example, an SVM) using the output results of one or more interlayers as feature amounts is learned, in addition to the processing of the first embodiment. Then, the neural network and the identification device connected to the neural network obtained by learning are used in an identification process in an information processing apparatus. A form like this will be explained in the second embodiment.

<Configuration and Operation of Information Processing Apparatus>

FIG. 5B is a view showing an example of the functional configuration of an information processing apparatus 20 according to the second embodiment. Compared to the configuration of FIG. 5A in the first embodiment, the information processing apparatus 20 shown in FIG. 5B additionally includes an identification unit 203 and an identification device holding unit 540, and the processing contents of an NN output unit 202 are different. Note that like an NN parameter holding unit 530, the identification device holding unit 540 may also be connected as a nonvolatile storage device to the information processing apparatus 20.

FIG. 8B is a flowchart showing the identification process performed by the information processing apparatus 20 according to the second embodiment. The processing contents in step T210 are the same as those in step T110 explained earlier, so an explanation thereof will be omitted. In step T220, the NN output unit 202 inputs an identification target image 100 to a pre-learned neural network, and outputs the output results of interlayers as shown in FIGS. 4B and 4C. The output results of the interlayers are transmitted to the identification unit 203. In step T230, the identification unit 203 inputs the output results of the interlayers obtained in step T220 to an identification device, and outputs the identification result. Note that the identification device is pre-learned and held in the identification device holding unit 540.

<Configuration and Operation of NN Learning Apparatus>

Next, a method of learning the identification device used in step T230 will be explained. As in the first embodiment, an NN learning apparatus 50 learns a neural network in an adaptive domain, and generates a lightweight neural network that outputs the same output results of interlayers except added conversion units and the same output result of the identification layer. The identification device is learned by using, as feature vectors, the output results of the interlayers obtained when inputting adaptive domain learning data to the lightweight neural network.

FIG. 6C is a view showing an example of the functional configuration of the NN learning apparatus according to the second embodiment. Many units are common to the NN learning apparatus 50 explained in FIG. 6A, but an identification device learning unit 505 and the identification device holding unit 540 are added to the NN learning apparatus 50 of the second embodiment.

FIG. 9C is a flowchart showing the learning process performed by the NN learning apparatus 50 according to the second embodiment. Processes in steps S210, S220, S230, S240, and S250 are the same as the first embodiment, so an explanation thereof will be omitted. A lightweight neural network obtained in step S250 is transmitted not only to the NN parameter holding unit 530 but also to the identification device learning unit 540.

In step S260, the identification device learning unit 505 learns the identification device by using the lightweight neural network obtained in step S250 and adaptive domain learning data held in an adaptive domain learning data holding unit 520. The identification device holding unit 540 holds parameters of the learned identification device. Note that the adaptive domain data used in learning by an adaptive domain learning unit 503 and the adaptive domain data used in learning by the identification device learning unit 505 are the same in this embodiment, but they may also be different. Note also that a recognition task to be learned when learning the identification device and a class category can be different from those used when learning a neural network in steps S210 and S230. For example, it is also possible to learn the neural network by an image classification task, and learn the identification device by a region dividing task.

More practical processing contents of step S260 will be explained below. In the second embodiment, an identification device using the output result of an interlayer as a feature vector is learned as shown in FIGS. 4B and 4C. To learn an identification device having a higher identification accuracy, it is favorable to integrally use the output results of a plurality of interlayers. An SVM (Support-Vector-Machine) can be used as the identification device. It is also possible to learn only a fullconnect layer by integrating the output results of a plurality of interlayers. In this case, parameters of the fullconnect layer are used as parameters of the identification device. The parameters of the identification device learned in step S260 are held in the identification device parameter holding unit 540, and used in identification.

Also, when using the identification device by using the output results of interlayers as feature vectors, the processes in steps S220 and S230 are different in some cases. Furthermore, after the neural network is learned by using a large number of images in step S210, it is also possible to learn the identification device by using a large number of images or adaptive domain data, and add conversion units based on the identification accuracy. In addition, learning parameters of each conversion unit can be set in step S230.

As an evaluation method, evaluation data in an adaptive domain is prepared and input to the neural network learned in step S110, thereby obtaining the output result of each interlayer.

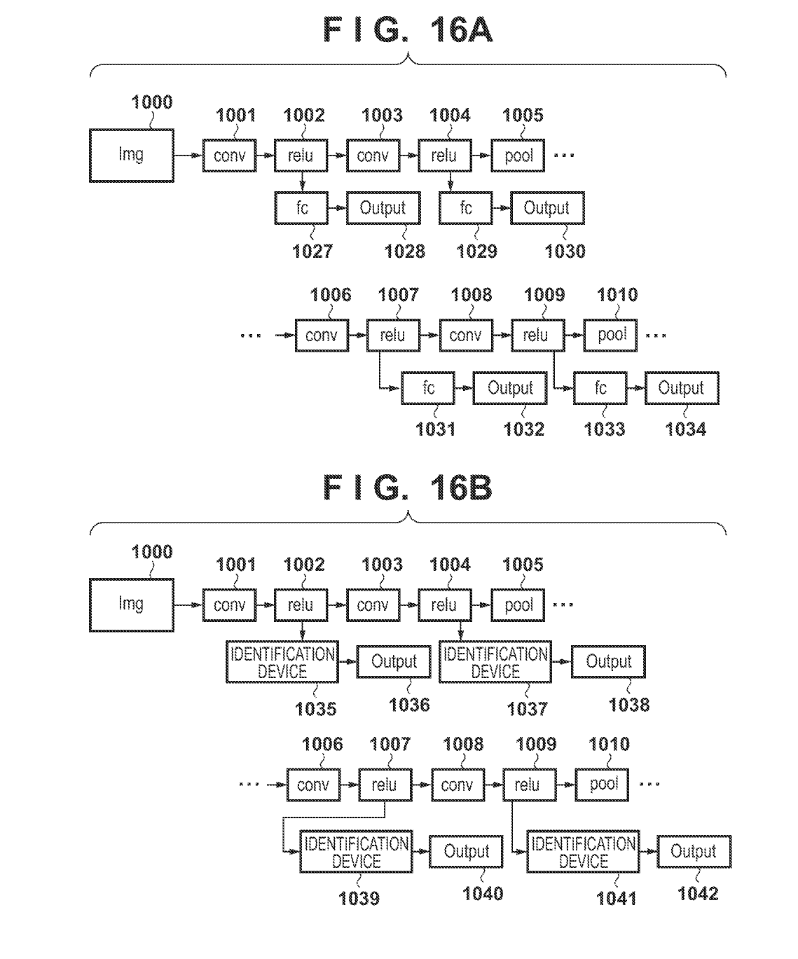

FIGS. 16A and 16B are views showing examples of the processing contents in the conversion unit addition step according to the second embodiment. FIG. 16A is a view showing a form in which the output results of interlayers are input to fullconnect layers 1027, 1029, 1031, and 1033. FIG. 16B is a view showing a form in which the output results of the interlayers are input to identification devices 1035, 1037, 1039, and 1041. Referring to FIGS. 16A and 16B, the identification results are output results 1028, 1030, 1032, 1034, 1036, 1038, 1040, and 1042. The identification accuracy of each of these identification results is evaluated. The fullconnect layers and identification devices used herein are pre-learned. For example, the identification accuracy is improved by inserting a conversion unit before an interlayer found to have a low identification accuracy, or increasing the learning rate of the conversion unit inserted in that position in step S230.

Note that in the above explanation, the processing of step S240 is performed after the processing of step S230 so as not to increase the network scale. However, the processing of step S240 need not be performed. For example, in step S260, the neural network to which the conversion units are added is directly used, and the identification devices are learned by using the output results of the interlayers except the conversion units as feature vectors. In this case, when using the identification devices in identification, the memory use amount for the feature vectors remains unchanged.

In the second embodiment as explained above, the NN learning apparatus 50 further learns identification devices using the output results of interlayers of a lightweight neural network as feature vectors, in addition to the first embodiment. These processes make it possible to learn a neural network having a high identification accuracy in an adaptive domain while suppressing an increase in network scale.

### Third Embodiment

In the third embodiment, a form in which learning is performed in an adaptive domain by selecting conversion units to be added when learning a neural network in the adaptive domain from prepared conversion units in addition to the processing of the first embodiment will be explained. An image identification process performed by an information processing apparatus 20 is the same as the first embodiment, so an explanation thereof will be omitted. A learning process performed by an NN learning apparatus 50 will be explained below.

<Configuration and Operation of NN Learning Apparatus>

FIG. 6D is a view showing an example of the functional configuration of the NN learning apparatus according to the third embodiment. Many units are common to the NN learning apparatus 50 explained in FIG. 6A, but a conversion unit holding unit 550 is added. Note that the learning process performed by the NN learning apparatus 50 according to the third embodiment is the same as the first embodiment and shown in FIG. 9A, except the processing contents in step S120. Therefore, the processing contents in step S120 will be explained below.

In step S120, a conversion unit addition unit 502 determines a conversion unit by selecting one conversion unit from one or more conversion units held in the conversion unit holding unit 550. Then, the determined conversion unit is added to a neural network learned in step S110. The arrangement and parameters of the neural network to which the conversion unit is added are transmitted to an adaptive domain learning unit 503.

For example, adaptive domain learning is performed beforehand for various adaptive domains by using a neural network to which conversion units are added by the method as explained in the first embodiment. A part or the whole of adaptive domain learning data obtained by the learning or feature amounts representing the characteristics of the adaptive domains are held. For example, the output results of interlayers when inputting a part of the adaptive domain learning data or typical data thereof to the neural network are held. The similarity between the held data and adaptive domain data to be learned this time is calculated, and a conversion unit added when learning adaptive domain data having a high similarity is added. The processing of succeeding step S130 can be performed by using the arrangement and parameters of this conversion unit as initial values. The processing contents are the same as the first embodiment, so an explanation thereof will be omitted.

This processing can increase the efficiency of the learning process in step S130, and enables learning having a high identification accuracy even when the amount of adaptive domain data is small. Note that as in the second embodiment, it is also possible to learn an identification device using the output result of an interlayer of a neural network as an input vector, and use the result in the information processing apparatus 20.

### Fourth Embodiment

In the fourth embodiment, a form in which a plurality of neural networks in an adaptive domain are learned and a neural network having a highest identification accuracy is selected in addition to the processing of the first embodiment will be explained. An image identification process in an information processing apparatus 20 is the same as the first embodiment, so an explanation thereof will be omitted. A learning process in an NN learning apparatus 50 will be explained below.

<Configuration and Operation of NN Learning Apparatus>

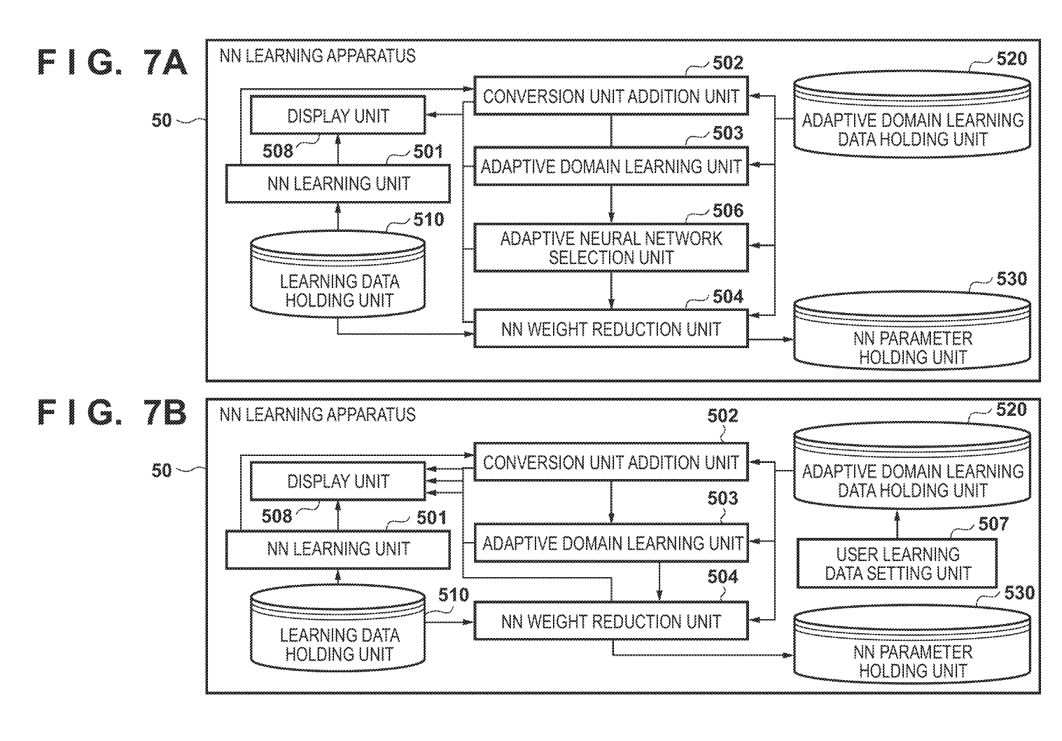

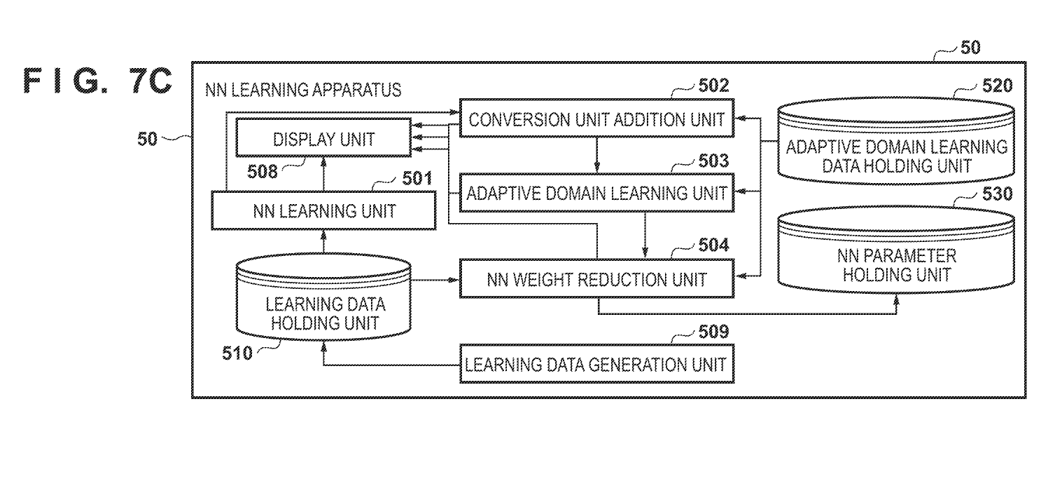

FIG. 7A is a view showing an example of the functional configuration of the NN learning apparatus according to the fourth embodiment. Many units are common to those of the NN learning apparatus 50 explained in FIG. 6A, but an adaptive NN selection unit 506 is added.

FIG. 9D is a flowchart showing the learning process performed by the NN learning apparatus 50 according to the fourth embodiment. The processing contents of step S310 are the same as those of step S110 of the first embodiment, so an explanation thereof will be omitted. The processing contents of step S320 are also the same as those of step S120 of the first embodiment, except that a plurality of neural networks to which conversion units are added by a plurality of methods are generated in the fourth embodiment. The processing contents of step S330 are the same as those of step S130 of the first embodiment, except that the neural networks to which the conversion units are added by the plurality of methods are learned in the fourth embodiment. Each learned neural network is transmitted to the adaptive NN selection unit 506 and a display unit 508.

In step S340, the adaptive NN selection unit 506 selects a neural network based on the identification accuracy to adaptive domain data from the plurality of neural networks learned in step S330. The selected neural network is transmitted to an NN weight reduction unit 504 and the display unit 508. The processing contents of step S350 are the same as those of step S150 of the first embodiment, so an explanation thereof will be omitted.

Note that for a plurality of neural networks to which different conversion units are added, adaptive domain learning can be performed by adding conversion units a plurality of times as in the other embodiments. Note also that in the above explanation, a neural network is selected based on the identification accuracy to the adaptive domain data after step S330. However, a neural network may also be selected based on the identification accuracy to the adaptive domain data after step S350. It is also possible to further learn the adaptive domain by further adding a conversion unit to the selected neural network. In addition, the user can select one of a plurality of neural networks by using a user interface (UI) on the display unit 508.

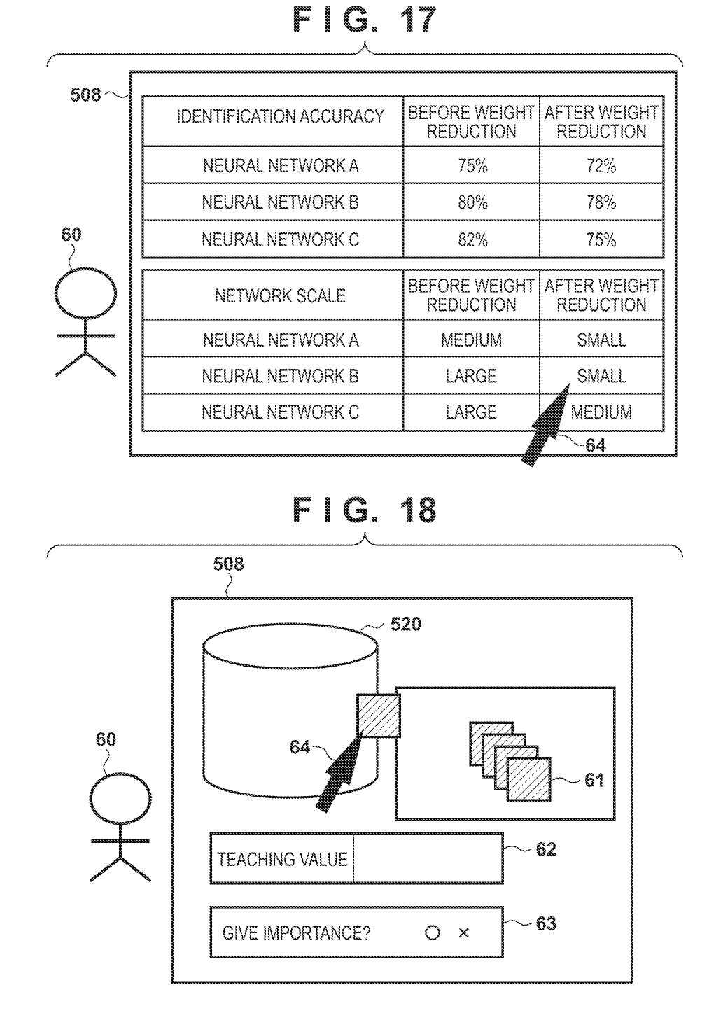

FIG. 17 is a view exemplarily showing a GUI for accepting selection of an NN. More specifically, FIG. 17 shows the way the display unit 508 displays neural networks A, B, and C having undergone adaptive domain learning, and a user 60 selects “the neural network B” having a high identification accuracy and a small network scale by using a pointer 64.

The above-described processing makes it possible to learn a neural network having a high identification accuracy in an adaptive domain while suppressing an increase in network scale. Note that as in the second embodiment, it is also possible to learn an identification device using the output result of an interlayer of a neural network as an input vector, and use the result in the information processing apparatus 20.

### Fifth Embodiment

In the fifth embodiment, a form in which a user sets learning data in an adaptive domain in addition to the processing of the first embodiment will be explained. An image identification process in an information processing apparatus 20 is the same as the first embodiment, so an explanation thereof will be omitted. A learning process in an NN learning apparatus 50 will be explained below.

<Configuration and Operation of NN Learning Apparatus>

FIG. 7B is a view showing an example of the functional configuration of the NN learning apparatus according to the fifth embodiment. Many units are common to those of the NN learning apparatus 50 explained in FIG. 6A, but a user learning data setting unit 507 is added.

FIG. 9E is a flowchart of the learning process performed by the NN learning apparatus 50 according to the fifth embodiment. The processing contents in steps S410 and S420 are the same as those in steps S110 and S120 of the first embodiment, so an explanation thereof will be omitted.

In step S430, the user learning data setting unit 507 sets learning data in an adaptive domain. The set learning data is transmitted to an adaptive domain learning data holding unit 520. This data set in step S430 contains:
Learning data and a teaching value in the adaptive domain
A teaching value of learning data in the adaptive domain
Selection of learning data important for learning in step S440

FIG. 18 is a view exemplarily showing a GUI for accepting setting of learning data. FIG. 18 shows the way a user 60 selects learning data 61 in an adaptive domain, and adds the learning data 61 to the adaptive domain learning data holding unit 520 by using a pointer 64. Referring to FIG. 18, the GUI also displays a dialogue 62 for inputting a teaching value, and a dialogue 63 for asking the user whether to give importance to learning data. The set learning data and teaching value in the adaptive domain are transmitted to the adaptive domain learning data holding unit 520, and used in succeeding step S440.

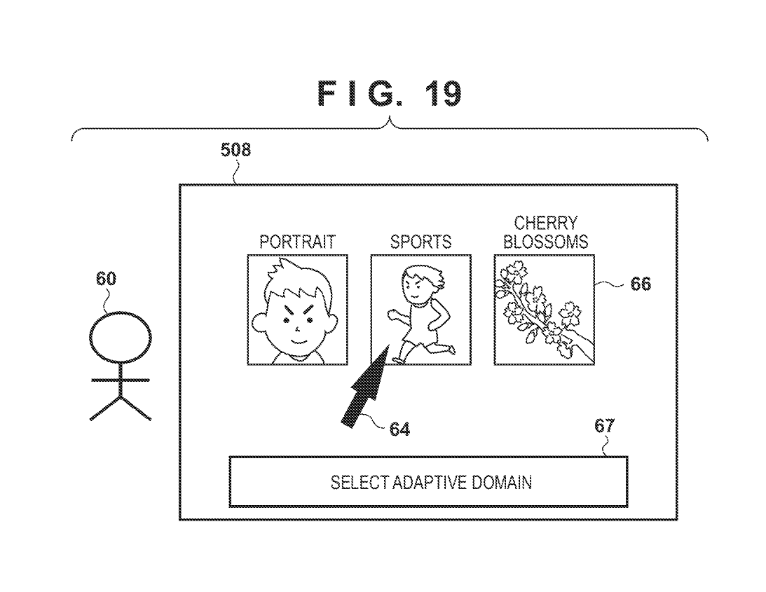

FIG. 19 is a view exemplarily showing a GUI for accepting selection of an adaptive domain. More specifically, the user 60 selects an adaptive domain in accordance with a dialogue 67 displaying “select adaptive domain”. In FIG. 19, the user 60 selects sports by using the pointer 64 from adaptive domains (portrait, sports, and cherry blossoms) indicated by a plurality of icons 66. The set adaptive domain information is transmitted to the adaptive domain learning data holding unit 520, and used in succeeding step S440. Thus, it is also possible to allow the user to select an adaptive scene itself in step S430.

In step S440, an adaptive domain learning unit 503 performs learning by selecting adaptive domain learning data based on the set adaptive domain information. Processing from step S440 and subsequent steps is almost the same as that from step S140 and subsequent steps in the first embodiment, so an explanation thereof will be omitted. When important learning data is selected, learning is performed by weighting in the processes in steps S440 and S460.

The above-described processing makes it possible to learn a neural network having a high identification accuracy in an adaptive domain while suppressing an increase in network scale. Note that as in the second embodiment, it is also possible to learn an identification device using the output result of an interlayer of a neural network as an input vector, and use the result in the information processing apparatus 20.

### Sixth Embodiment

In the sixth embodiment, a form in which learning for adaptive domain data is performed after a neural network is pre-trained by generating a large number of images by an image generation unit in addition to the process of the first embodiment will be explained. In this embodiment, a neural network is pre-trained by using a large number of images generated by the image generation unit, and a conversion unit is learned by adaptive domain data. An image identification process in an information processing apparatus 20 is the same as the first embodiment, so an explanation thereof will be omitted. A learning process in an NN learning apparatus 50 will be explained below.

<Configuration and Operation of NN Learning Apparatus>

FIG. 7C is a view showing an example of the functional configuration of the NN learning apparatus according to the sixth embodiment. Many units are common to the NN learning apparatus 50 explained in FIG. 6A, but a learning data generation unit 509 is added.

FIG. 9F is a flowchart of the learning process performed by the NN learning apparatus 50 according to the sixth embodiment. In step S510, the learning data generation unit 509 generates a large amount of learning data to be used in step S520. The generated learning data is transmitted to a learning data holding unit 510. The processing contents in steps S520 to S560 are the same as those in steps S110 to S150 of the first embodiment, so an explanation thereof will be omitted.

More practical processing contents of step S510 will be explained. In this embodiment, an example in which learning data is formed by using the CG technology will be explained. The explanation will be made by assuming that a recognition task is body detection. For example, as disclosed in ‘Hironori Hattori, “Learning Scene-Specific Pedestrian Detectors without Real Data”, Computer Vision and Pattern Recognition 2015’, human models are generated by various patterns and arranged in various positions in a scene by using various patterns of postures and clothes, thereby generating CG images. In this literature, CG images to be generated are adjusted in accordance with an adaptive scene, but the scene need not be limited. Note that neural network learning requires a large number of images, so CG images are generated on the order of millions to tens of millions in step S510. The generated learning images are transmitted to the learning data holding unit 510. Note that in this embodiment, an example in which the learning data to be used in step S520 is generated by using the CG technology is explained. However, it is also possible to mix real image data and CG data.

These processes make it possible to learn a neural network having a high identification accuracy in an adaptive domain while suppressing an increase in network scale. Note that as in the second embodiment, it is also possible to learn an identification device using the output result of an interlayer of a neural network as an input vector, and use the result in the information processing apparatus 20.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-071041, filed Apr. 2, 2018, which is hereby incorporated by reference herein in its entirety.

What is claimed is:

1. A learning apparatus for learning a multilayer neural network (multilayer NN), comprising:
a first learning unit configured to learn a first multilayer NN by using a first data group;
a first generation unit configured to generate a second multilayer NN by inserting a conversion unit for performing predetermined processing between a first layer and a second layer following the first layer in the first multilayer NN; and
a second learning unit configured to learn the second multilayer NN by using a second data group different in characteristic from the first data group.

2. The apparatus according to claim 1, further comprising a second generation unit configured to generate a third multilayer NN having substantially the same output characteristic as that of the learned second multilayer NN and a network scale smaller than that of the second multilayer NN.

3. The apparatus according to claim 2, wherein the second generation unit generates the third multilayer NN by using at least one of the first data group and the second data group.

4. The apparatus according to claim 1, wherein the second learning unit sets a learning rate of the conversion unit to be higher than that of other layers in learning using the second data group.

5. The apparatus according to claim 4, wherein the second learning unit sets the learning rate of a layer except the conversion unit at zero.

6. The apparatus according to claim 1, wherein
the first generation unit generates the second multilayer NN by inserting a plurality of conversion units into the first multilayer NN, and
the second learning unit sets a lower learning rate for a conversion unit closer to an input layer of the second multilayer NN, among the plurality of conversion units.

7. The apparatus according to claim 1, wherein the first generation unit inserts the conversion unit based on identification accuracy of an output result of each layer included in the first multilayer NN.

8. The apparatus according to claim 1, wherein the first generation unit determines the conversion unit to be inserted, based on a feature of the second data group.

9. A method of controlling a learning apparatus for learning a multilayer neural network (multilayer NN), comprising:
learning a first multilayer NN by using a first data group;
generating a second multilayer NN by inserting a conversion unit for performing predetermined processing between a first layer and a second layer following the first layer in the first multilayer NN; and
learning the second multilayer NN by using a second data group different in characteristic from the first data group.

10. A non-transitory computer-readable recording medium storing a program that causes a computer to function as a learning apparatus for learning a multilayer neural network (multilayer NN), comprising:
a first learning unit configured to learn a first multilayer NN by using a first data group;
a first generation unit configured to generate a second multilayer NN by inserting a conversion unit for performing predetermined processing between a first layer and a second layer following the first layer in the first multilayer NN; and
a second learning unit configured to learn the second multilayer NN by using a second data group different in characteristic from the first data group.
